(19) United States
(12) Patent Application Publication
(10) Pub. No.: US 2025/0229474 A1
(43) Pub. Date: Jul. 17, 2025

(54) Apparatus and method for producing plastic preforms with infrared image recording device

(71) Applicant: KRONES AG, Neutraubling (DE)

(72) Inventors: Dieter WUENSCHE, Straubing (DE); Stefan SCHOBER, Tegernheim (DE); Anton NIEDERMEIER, Offenstetten (DE); Florian GELTINGER, Donaustauf (DE); Andreas ROTH, Erlangen (DE)

(21) Appl. No.: 19/021,994

(22) Filed: Jan. 15, 2025

(30) Foreign Application Priority Data
Jan. 15, 2024 (DE) 10 2024 101 048.7

(51) Int. Cl. B29C 49/78; B29C 49/06

(52) U.S. Cl. CPC B29C 49/78; B29C 49/06; B29C 2049/7861; B29C 2049/7876

(57) ABSTRACT

An apparatus for producing plastic preforms has a production device having production units configured for producing a plastic preform, wherein these plastic preforms are each formed in one piece and have at least one main body and a threaded portion arranged on the main body, and a removal device that is configured for jointly removing the plastic preforms manufactured from this production device. The removal device has a carrier and transport device configured for holding the removed plastic preforms, and for transporting the carrier jointly with the plastic preforms, removed by the removal device, and an inspection device having at least one infrared image recording device that is configured for recording a spatially resolved image of at least one region of a plurality of the plastic preforms produced and for outputting at least one measured value that is characteristic of a physical property of the plastic preforms.

### BACKGROUND OF THE INVENTION

The present invention relates to an apparatus and a method for producing plastic preforms. Such apparatuses and methods have long been known from the prior art. For example, injection-molding machines are used to produce such plastic preforms—for example, from PET. In apparatuses and methods known from the prior art, plastic preforms are usually produced in a separate work step and later processed into containers using other machines such as stretch blow molding machines.

More recently, efforts have been made to integrate the production process for plastic preforms into a corresponding container treatment system. This has the advantage that the plastic preforms produced are warm as a result of the production process, which means that energy can be saved for further heating of the plastic preforms.

In the prior art, it is not common practice to monitor injection-molding machines. After the injection-molding process, plastic preforms that are produced are usually transported further in mesh boxes or octabins or on belts, without being examined. Therefore, there is currently no known monitoring of an injection-molding machine for recognizing possible failures of individual injection-molding cavities at an early stage.

DE 10 2000 1618 670 A1 discloses a method and an apparatus for testing plastic preforms. The plastic preforms are transported on conveyor belts and inspected as they are transferred from one conveyor belt to the other.

An optical inspection system for plastic preforms is known from WO 2018/036857 A1. The plastic preforms are inspected with at least one camera device in such a way that the plastic preforms are in a relative position to one another that is unchanged compared to the injection-molding process.

DE 602 8 756 T2 also discloses a method and an apparatus for handling ejected injection-molded parts.

The present invention is based upon the object of monitoring, in particular, an apparatus for producing plastic preforms, such as an injection-molding machine.

### SUMMARY OF THE INVENTION

An apparatus according to the invention for producing plastic preforms has a production device that has a plurality of production units and/or cavities, wherein each of these cavities are suitable and intended for producing a plastic preform, and wherein these plastic preforms in each case are formed in one piece and have at least one main body and a threaded portion arranged on the main body.

Furthermore, the apparatus has a removal device that is suitable and intended for removing the plastic preforms manufactured by the production device from this production device, in particular jointly. Furthermore, the removal device has a carrier that is suitable and intended for holding the removed plastic preforms, and with a transport device that is suitable and intended for transporting the carrier jointly with the plastic preforms, removed by the removal device, in a predefined transport direction, wherein the apparatus has an inspection device for inspecting the manufactured plastic preforms.

According to the invention, the inspection device has at least one infrared image recording device that is suitable and intended for recording a spatially resolved image of at least one region of a plurality of the manufactured plastic preforms.

Therefore, it is proposed in the context of the invention that the inspection of the plastic preforms already be performed in the production device and/or as part of the production process.

In this manner, an option is created for monitoring the plastic preforms directly after their production or injection molding with the aid of an inspection device and, in particular, an infrared measuring system and, preferably, for recognizing possible temperature differences that can be traced back to worn and/or defective cavities, heaters, or defective cooling units or a defective injection-molding process in the particular quality.

With the aid of this infrared monitoring, faults in the injection-molding machine can therefore be recognized and rectified at an early stage, in particular before failures occur. In addition, plastic preforms that have been injected incorrectly can be recognized and preferably ejected.

Preferably, the infrared image recording device and/or an evaluation device allocated thereto is suitable and intended for outputting at least one measured value that is characteristic of a physical property of the plastic preforms (for example, their temperature). For example, the temperatures of the plastic preforms can be deduced from the recorded images.

Particularly preferably, said carrier is suitable and intended for holding the plastic preforms at least partially at equidistant positions relative to one another, in particular also in a mutually parallel alignment (of the plastic preforms). For example, this carrier can have a plurality of openings, each of which is suitable and intended for receiving a plastic preform. These openings can be arranged as an array.

In a preferred embodiment, the apparatus has a receiving device that is suitable and intended for receiving the plastic preforms from the carrier.

Preferably, this receiving device has a plurality of receiving units, each of which is suitable and intended for receiving individual plastic preforms from the carrier. These receiving units can be vacuum grippers, for example, which are suitable and intended for receiving the plastic preforms. Therefore, the receiving device preferably has independently controllable receiving elements, each of which is suitable and intended for receiving a plastic preform.

Preferably, as mentioned, these are vacuum grippers, each of which can be placed on a mouth of the plastic preforms.

In a further advantageous embodiment, the infrared recording device is suitable and intended for detecting radiation that is in a wavelength range of 4,000 nm to 20,000 nm, preferably in a wavelength range of 6,000 nm to 8,000 nm, and particularly preferably in a wavelength range of 8,000 nm to 15,000 nm.

In a further preferred embodiment, the infrared image recording device is suitable and intended for outputting a value characteristic of a temperature of the plastic preforms and is preferably suitable and intended for outputting, for each of the plastic preforms inspected, at least one value characteristic of the temperature thereof. Preferably, therefore, the infrared image recording device and/or an evaluation device is suitable and intended for outputting a plurality of measured values, which preferably correspond to at least the number of transported plastic preforms.

Preferably, each of these measured values is and/or will be assigned to at least one and preferably exactly one plastic preform produced.

For this purpose, the inspection device can have an evaluation device for evaluating recorded images, which preferably detects and/or identifies each individual plastic preform recorded by the infrared image recording device. Preferably, a characteristic measured value is detected for each of these plastic preforms—for example, a measured value characteristic of a temperature of this plastic preform.

This is in particular also feasible because the infrared image recording device preferably has a predefined and fixed position in relation to the carriers fitted with the plastic preforms.

Emissivity is also a key factor in the measurement of physical parameters described here, in particular the temperatures of the plastic preforms. It is dependent upon various influences and can therefore be adjusted here for the production of plastic preforms, depending upon the application. For example, plastics with a thickness of more than 0.4 mm can be measured very well in the long infrared spectral range (8,000 nm-14,000 nm) with emissivities greater than 0.9.

Preferably, the inspection device has a calibration device that is suitable and intended for calibrating the infrared image recording device, in particular taking into account the plastic preforms produced and/or to be produced.

It is possible that the inspection device has an area scan camera, but it would also be possible to use a line scan camera. It would also be possible to take one or more images and unroll them at a predefined angle—for example, an angle of at least 180°, preferably at least 360°.

Preferably, the inspection device is configured and intended or arranged in such a way that it is suitable and intended for inspecting the plastic preforms held by the carriers at least in certain regions and preferably exactly in certain regions (for example, in the region of the thread of the plastic preform or the region of the main body (to be expanded) of the plastic preform).

In a further advantageous embodiment, the inspection device is arranged in such a way that it is suitable and intended for inspecting the plastic preforms held by the receiving device.

It is possible that the inspection device inspects predefined regions of the plastic preforms—for example, their mouths or their main bodies.

In a further advantageous embodiment, the apparatus has an assignment device that is suitable and intended for assigning to a plastic preform inspected by the inspection device, and in particular to each of these plastic preforms inspected by the inspection device, the particular production unit and/or cavity that has produced this plastic preform. Due to this in particular clear assignment, more precise control and/or regulation of the production device is preferably also possible, as described below.

In a further advantageous embodiment, the apparatus has a control device for controlling the production device, wherein this control device is preferably suitable and intended for controlling each of the production units. In this manner, the production device can be individually controlled and, in particular, regulated.

Preferably, the control device is suitable and intended for controlling and in particular regulating the production device and/or the individual production units (in each case) on the basis of at least one measured value.

Preferably, this control device is suitable for controlling and/or regulating at least one parameter and preferably a plurality of parameters that are characteristic of the operation of the production device and/or the production units.

Preferably, the parameter or these parameters is or are selected from a group of parameters that contains valve gate times, injection delays, a temporal behavior of the injection (of plastic mass), a pressure profile, a holding pressure, in particular a pressure profile of the holding pressure, and a time duration of the holding pressure, a cooling time, and the like.

In addition, the parameter can also be at least one temperature, in particular a temperature of a cavity for producing the plastic preforms, a temperature of a nozzle, in particular an injection nozzle for a plastic mass, a temperature of a hot runner, or a temperature of one or more heating zones of the plasticizing process.

In addition, the parameter can also be selected from a group of parameters that contains a speed of a (conveying) screw, a back pressure of the melt, or a position and/or a pressure of a closing unit (in particular, during injection compression molding).

In particular, regulation is possible on the basis of the temperature values of the individual plastic preforms measured by the infrared image recording device.

In a further preferred embodiment, the (infrared) inspection device is also suitable and intended for detecting said physical value for each plastic preform in a spatially resolved manner.

Therefore, it is preferably possible, for example, not only to determine or ascertain the temperature of the individual plastic preforms, but also to determine this temperature on the basis of the plastic preforms (and/or with respect to the plastic preforms) in a spatially resolved manner—for example, to detect that certain regions of the thread are cooler than other regions.

Particularly preferably, the individual production units are controlled on the basis of the recorded image and, in particular, the determined temperature values. For example, the individual production units can have individual heating devices that are controlled and/or can be controlled independently of one another. It is also possible, for example, to control the contact pressure in the production units. It is also possible, for example, to influence the material distribution of the plastic fed to the production units.

In a further advantageous embodiment, the apparatus has a cooling device that is suitable and intended for cooling the plastic preforms produced by the production device, at least in sections. Preferably, this cooling device is also integrated into the production process. Particularly preferably, a removal and/or a transport of the plastic preforms are only carried out after they have been cooled or after the individual plastic preforms have been cooled.

Preferably, the cooling device can be controlled and, in particular, can be controlled and, in particular, regulated on the basis of an inspection result of the inspection device.

It is also possible that this cooling is carried out before the plastic preforms are removed or, preferably, after they have been removed from the individual production units. This makes it possible, for example, for the cooling device to cool the plastic preforms located in the carrier. Cooling can be achieved, for example, by applying the plastic preforms to air or a cooling liquid. Cooling by convection is also possible.

In a further preferred embodiment, the production device has a plasticizing unit. This can have an injection unit that is suitable for injecting plastic material. This injection unit preferably has a screw conveyor for conveying the plastic material and preferably a nozzle that is connected to this screw conveyor.

In addition, the production device has at least one material feed device that is suitable and intended for feeding a plastic material, and in particular a plastic material in granular form.

In a further preferred embodiment, the production device has a drying device for drying the plastic granulate to be fed.

In a further preferred embodiment, the apparatus has a second inspection device for inspecting the manufactured plastic preforms, wherein the second inspection device has at least one image recording device and preferably at least one infrared image recording device, which is suitable and intended for recording at least one spatially resolved image of at least a second region of a plurality of the plastic preforms manufactured.

In this case, the second inspection device can also be embodied in the manner described above, so that there is no need to repeat the individual features described above.

It is also possible that the production device is controlled on the basis of values output by this second inspection device (and in particular on the basis of measured temperatures of the plastic preforms).

In a further advantageous embodiment, the apparatus has a further inspection device for inspecting the manufactured plastic preforms. This can, for example, be an image recording device that records spatially resolved images of the plastic preforms and that, in particular, is not an infrared image recording device, but a camera or image recording device that records images in the visible wavelength range.

This further image recording device can be used, for example, in order to recognize defects on individual plastic preforms, such as incompletely formed mouths of the containers, or also holes or the like.

Preferably, the above-mentioned assignment device is also suitable and intended for assigning to the plastic preforms recorded by the further image recording device in each case those production units which have produced these plastic preforms.

Preferably, the production device can also be controlled taking into account the measured values output by the further inspection devices.

Preferably, the apparatus also has an illumination device to illuminate the plastic preforms inspected by this further inspection device.

The present invention is further directed towards a method for producing plastic preforms, having a production device that has a plurality of production units and/or cavities, wherein each of these production units and/or qualities produces a plastic preform, and wherein these plastic preforms are each formed in one piece and have a main body and a threaded portion arranged on the main body.

Furthermore, the apparatus has a removal device that jointly removes the plastic preforms manufactured by the production device from this production device, wherein the removal device has a carrier that holds the removed plastic preforms. Furthermore, a transport device is provided which transports the carrier with the plastic preforms, removed by the removal device, in a predefined transport direction, wherein the apparatus has an inspection device that inspects the manufactured plastic preforms.

According to the invention, the inspection device has at least one first infrared image recording device that records a spatially resolved image of at least one region of a plurality of the manufactured plastic preforms, and outputs at least one value that is characteristic of a physical property and preferably a temperature of the plastic preforms inspected.

Particularly preferably, the infrared image recording device records images of the plastic preforms immediately after their removal and/or during transport with the first transport device. It is possible that the infrared image recording device records an image during the movement of these plastic preforms and/or this transport device.

Particularly preferably, an evaluation device evaluates the recorded images in such a way that a value characteristic of this plastic preform is assigned to each of the detected plastic preforms, and, in particular, a value characteristic of its temperature is assigned.

Particularly preferably, the production device or the individual production units of the production device are controlled and in particular regulated taking into account these measured values detected for each individual plastic preform.

In a further preferred method, a receiving device receives the plastic preforms from the carrier. This receiving device preferably has a plurality of receiving elements, each of which receives a plastic preform. In particular, these receiving elements receive the individual plastic preforms using a vacuum or negative pressure.

In a further preferred embodiment, a turning device turns the plastic preforms held by the receiving device, so that their alignment is changed. Preferably, the turning device turns the plastic preforms by a predefined angle, and in particular by an angle of 90°.

### BRIEF DESCRIPTION OF THE DRAWINGS

Further advantages and embodiments can be seen in the accompanying drawings, in which:

FIG. 1 shows a rough schematic representation of an apparatus according to the invention;

FIG. 2 shows a representation of a production device for producing plastic preforms in a first view;

FIG. 3 shows a further view of the production device shown in FIG. 2;

FIG. 4 shows a representation for illustrating the method according to the invention;

FIG. 5 shows a representation of an apparatus according to the invention; and

FIG. 6 shows a detailed representation of an apparatus according to the invention

### DETAILED DESCRIPTION OF THE INVENTION

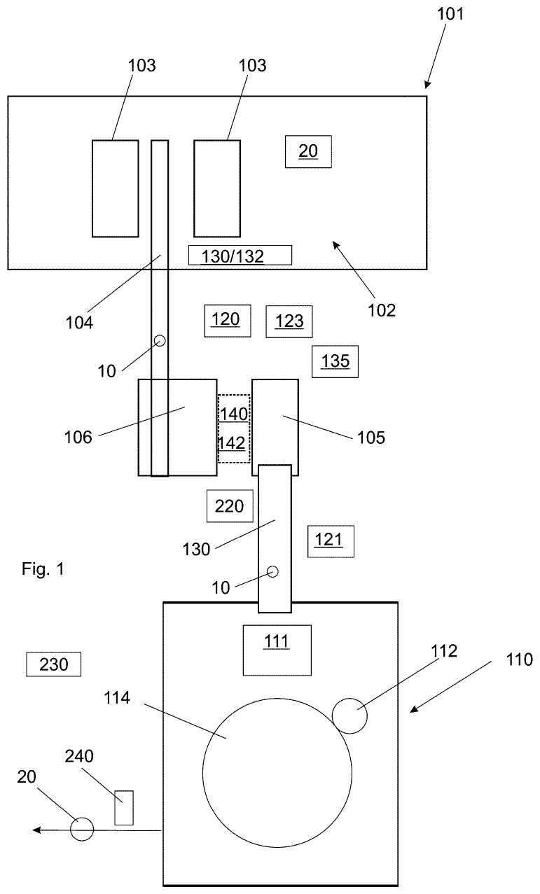

FIG. 1 shows a rough schematic representation of an apparatus 101 for producing plastic containers. This apparatus 101 has a production device 102 that produces plastic preforms 10. Preferably, this production device 102 is an injection-molding machine here. This production device 102 has a plurality of production units and in particular forming tools, each of which is suitable and intended for producing individual plastic preforms 10.

These production units preferably each have cavities that are suitable and intended for producing the plastic preforms. Preferably, these production units 103 can be controlled independently of one another. Preferably, heating elements are assigned to each of these production units.

Reference sign 104 schematically designates a removal device that removes the injection-molded plastic preforms 10 from the production units 102. Preferably, this removal device is suitable and intended for removing all of the plastic preforms jointly from the production units and/or the cavities. Preferably, this removal device is suitable and intended for removing the individual plastic preforms from the production units by moving the plastic preforms in their longitudinal direction.

Reference sign 106 designates a cooling device, in particular in the form of a post-cooling unit, which cools the plastic preforms 10 produced. Preferably, the plastic preforms are placed in this cooling device 106 and/or fed to the cooling device directly after their production.

Reference sign 130 designates an inspection device according to the invention having an infrared image recording device 132, which records an image of the plastic preforms removed or to be removed. This inspection device is preferably suitable for detecting each individual plastic preform manufactured.

An inspection device and in particular a first temperature detection device 120 is arranged along the transport path of the transport device 104, which first temperature detection device detects a temperature of the plastic preforms or a value characteristic thereof and in particular detects them in a contactless manner. This first temperature detection device 120 is in particular suitable and intended for detecting the temperature of each individual plastic preform 10. In addition to or instead of the temperature detection device, an inspection device can also be provided at this point that detects at least one value characteristic of the plastic preform.

Reference sign 135 designates an assignment device that assigns a production unit 103, which has produced this plastic preform, to each plastic preform 10 whose temperature has been detected. The production device 101 preferably has at least one control device 21 that is suitable and intended for controlling the individual production units, also on the basis of the measured temperatures of the individual plastic preforms.

Preferably, this assignment device is suitable for assigning to each plastic preform detected by the inspection device 130 the production unit 103 that produced it.

Reference sign 105 designates a transport device and, in particular, a handling unit that receives the plastic preforms 10 from the transport device 104. This handling unit can, for example, be a receiving device, such as the aforementioned receiving device, which is suitable and intended for receiving the plastic preforms from a carrier. Preferably, this receiving device is suitable and configured for receiving each plastic preform individually.

Additionally or alternatively, the assignment device 130 is also preferably able to assign to each plastic preform the forming station 112 that will form that plastic preform into a plastic container.

Preferably, therefore, the first temperature detection device is arranged between the production device and/or the individual production units and the cooling device 106 and/or the transport device 105.

Reference sign 121 designates a further inspection device that detects at least one value characteristic of the plastic preform inspected in each case. Here too, the value can preferably again be a value that is selected from a group of values that contains a geometry of the plastic preforms, a color of the plastic preforms, a humidity of the plastic preforms, an IV value of the plastic preforms, a temperature of the plastic preforms, or the like.

Preferably, these values are made available to a higher-level controller in order to control parameters of the entire apparatus.

Furthermore, a second inspection device (not shown) with an infrared image recording device (not shown) is optionally provided for inspecting the plastic preforms.

Furthermore, a discharge device can be provided that (in particular on the basis of the aforementioned characteristic values) ensures that individual plastic preforms are not transferred to the forming device 112.

Furthermore, a gap closing device (not shown) can be provided that closes gaps created by the discharge of individual plastic preforms.

Reference sign 110 designates as a whole a forming device that forms the plastic preforms into plastic containers 20.

In this case, a heating device 111 is initially preferably provided that heats the plastic preforms to a temperature that is suitable for forming and, in particular, expanding them into the plastic containers 20.

The forming device 110 preferably has a rotatable carrier 114 on which a plurality of forming stations 112 are arranged. These forming stations are preferably controllable independently of one another.

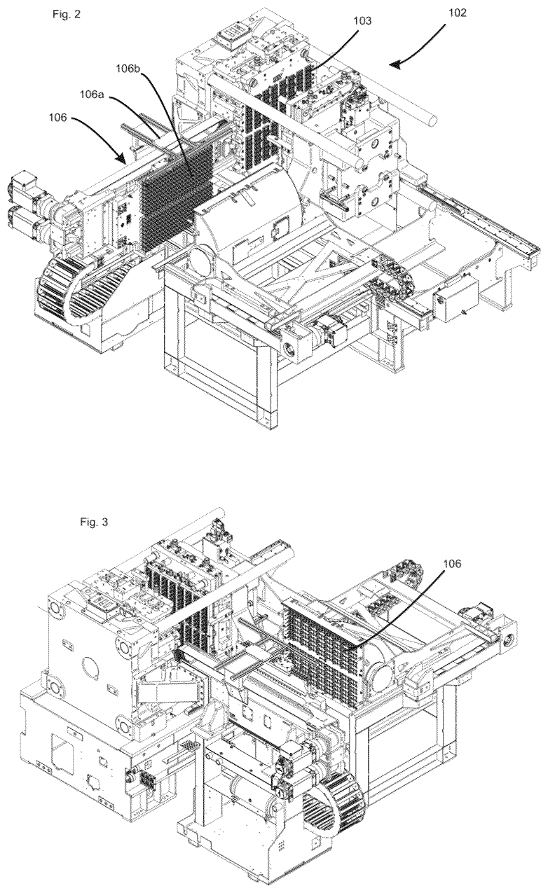

FIG. 2 and FIG. 3 show a first view of a production device 102 for producing the plastic preforms. Reference sign 103 designates a plurality of production units, each of which produces individual plastic preforms.

Reference sign 106 designates a cooling device for cooling the plastic preforms. Reference sign 106a designates a removal device for removing the plastic preforms after the production process.

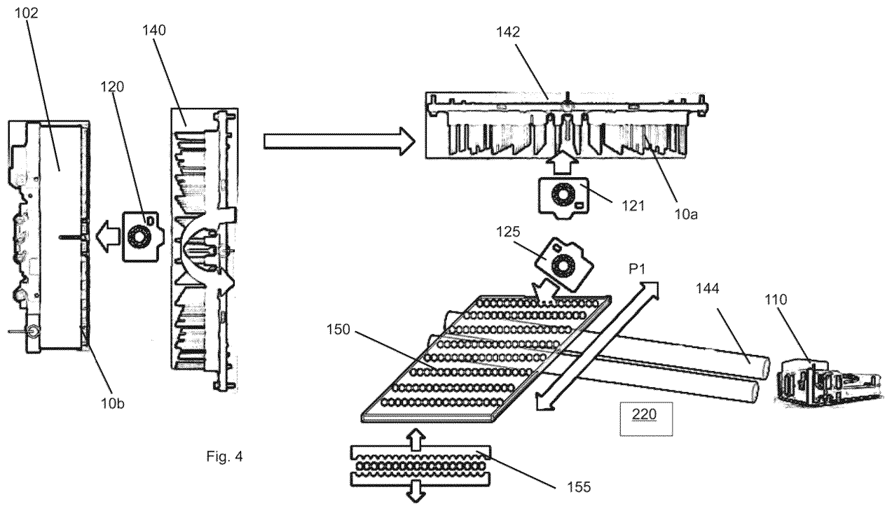

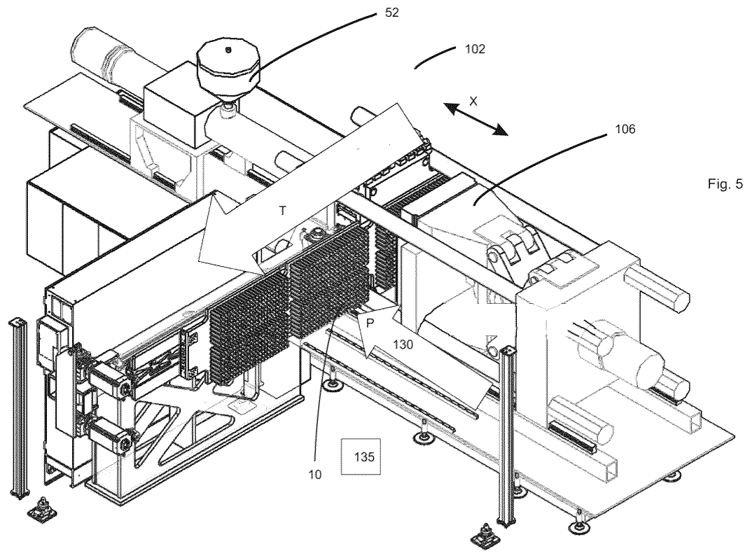

FIG. 4 shows a representation for illustrating the apparatus according to the invention and the method according to the invention.

The production device 102 is provided, which has a plurality of production units (not shown in detail), which in each case produce the plastic preforms. One recognizes the mouths 10b of the individual plastic preforms.

Reference sign 120 designates the first inspection device, which here in particular records an image of the mouths 10b, wherein the individual mouths and thus the individual plastic preforms can be individualized.

Reference sign 140 designates a turning device that turns the carrier with the plastic preforms arranged on it—in this case by 90°. In addition, the plastic preform is cooled in this region by a cooling device (not shown here).

The turned carrier 142 is transported with the plastic preforms arranged thereon, and a second inspection device 121 records at least one image of the plastic preforms-more precisely, now of the main bodies 10a of the plastic preforms.

Reference sign 125 designates a third inspection device, which also inspects the plastic preforms arranged in a carrier. Preferably, an inspection for material defects such as so-called BlackSpecs takes place here.

A vacuum holding device (not shown) is provided in the region of the carrier 142, which ensures that each individual plastic preform is held on its own carrier. In this manner, defective plastic preforms can be separated from correct plastic preforms.

In the embodiment shown in FIG. 4, defective plastic preforms are initially still held by their (vacuum) grippers, while correct plastic preforms are dropped onto a further transport unit 150.

From this further transport unit in the form of a carrier 150, the preforms can in turn be dropped onto a further transport unit 144, which in this case comprises two rollers arranged parallel to one another, between which the plastic preforms 10 are guided. For this purpose, the carrier 150 with the individual plastic preforms can be displaced along the arrow P1 relative to the further transport unit.

Strictly speaking, the carrier with the plastic preforms is moved laterally over the transport unit 144. For this purpose, gaps 155 can open on the carrier, as shown in FIG. 4 below, and the plastic preforms can be dropped between the rollers.

The defective plastic preforms, which are still held on the carrier 142 by vacuum grippers, can be ejected by selective control when the carrier 142 is retracted.

FIG. 5 shows a more detailed representation of production device 102. This has a feed device 52 for feeding a plastic material, e.g., PET. At least one heating device for heating the plastic is arranged inside a housing.

Furthermore, a plurality of production units are provided (not shown), each of which produces individual plastic preforms. In addition, at least one plasticizing unit is provided and, advantageously, also a screw conveyor for conveying plastic mass.

Preferably, each of these production units has a cavity for molding the plastic preforms, and preferably also a heating element allocated to this cavity for heating the cavities. Preferably, these are electrically operated heating elements.

The individual plastic preforms are removed by a removal device 104 and, in particular, removed from the individual cavities and/or production units. Reference sign 106 designates the cooling device. This is preferably movable in the longitudinal direction of the plastic preforms (here, in the direction X).

A transport device transports a carrier with the plastic preforms held by it in the transport direction T.

Reference sign 130 designates an inspection device that inspects the plastic preforms held by the carrier in the direction of observation shown by the arrow. Preferably, this inspection device 130 and preferably an evaluation device assigned to this inspection device are able to evaluate the recorded images in such a way that individual plastic preforms produced can be detected. The inspection device preferably outputs a value for each individual plastic preform, which is characteristic of this preform and in particular for a temperature of this plastic preform 10.

Reference sign 135 schematically designates an assignment device that assigns to each plastic preform 10 inspected by the inspection device the production unit 103 that has produced this plastic preform.

Reference sign 20 again designates the control device for controlling and in particular regulating the production device 102, which is in particular suitable and intended for individually controlling and in particular regulating the individual production units 103.

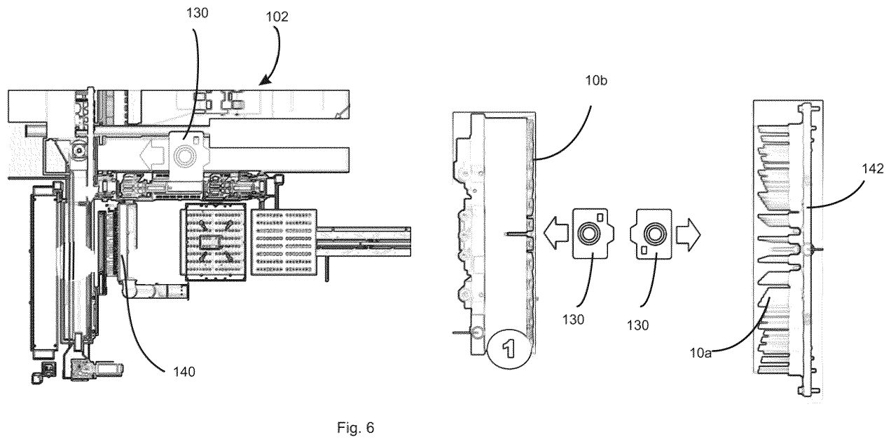

FIG. 6 shows a further configuration of the apparatus according to the invention. The receiving device 142, which receives the individual plastic preforms from the transport device, is also shown here.

In the right partial image of FIG. 6, two possible positions of the inspection device are shown, wherein the left inspection device 130 can be used to inspect the mouths 10b of the plastic preforms, and the right inspection device 130 can be used to inspect their main bodies 10a.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for producing plastic preforms, having a production device that has a plurality of production units, wherein each of these production units is configured for producing a plastic preform, wherein these plastic preforms are each formed in one piece and have at least one main body and a threaded portion arranged on the main body, wherein the apparatus has a removal device that is configured for jointly removing the plastic preforms manufactured by the production device from this production device, wherein the removal device has a carrier that is configured for holding the removed plastic preforms, and a transport device that is configured for transporting the carrier jointly with the plastic preforms, removed by the removal device, in a predefined transport direction, wherein the apparatus has an inspection device for inspecting the manufactured plastic preforms,
wherein
the inspection device has at least one infrared image recording device that is configured for recording a spatially resolved image of at least one region of a plurality of the plastic preforms produced and for outputting at least one measured value that is characteristic of a physical property of the plastic preforms.

2. The apparatus according to claim 1,
wherein
the apparatus has a receiving device that is configured for receiving the plastic preforms from the carrier.

3. The apparatus according to claim 2,
wherein
the receiving device has a plurality of receiving units, each of which is configured for receiving individual plastic preforms from the carrier.

4. The apparatus according to claim 1,
wherein
the infrared image recording device is configured for detecting radiation that is in a wavelength range of at least 4,000 nm-20,000 nm.

5. The apparatus according to claim 1,
wherein
the infrared image recording device is configured for outputting a value that is characteristic of a temperature of the plastic preforms.

6. The apparatus according to claim 1,
wherein
the inspection device is arranged in such a way that it is configured for inspecting the plastic preforms held by the carrier, and/or the inspection device is arranged in such a way that it is configured for inspecting the plastic preforms held by the receiving device.

7. The apparatus according to claim 1,
wherein
the apparatus has an assignment device that is configured for assigning to a plastic preform inspected by the inspection device the production unit that has produced this plastic preform.

8. The apparatus according to claim 1,
wherein
the apparatus has a control device for controlling the production device.

9. The apparatus according to claim 8,
wherein
the control device is configured for controlling the production device and/or the individual production units on the basis of the at least one measured value.

10. The apparatus according to claim 1,
wherein
the apparatus has a cooling device that is configured for cooling the plastic preforms produced by the production device, at least in sections.

11. The apparatus according to claim 1,
wherein
the apparatus has a second inspection device for inspecting the manufactured plastic preforms, wherein the second inspection device has at least one image recording device.

12. A method for producing plastic preforms, having a production device that has a plurality of production units, wherein each of these production units produces a plastic preform, wherein these plastic preforms are each formed in one piece and have at least one main body and a threaded portion arranged on the main body, wherein the apparatus has a removal device that removes the plastic preforms manufactured by the production device jointly from this production device, wherein the removal device has a carrier that holds the removed plastic preforms, and a transport device that transports the carrier with the plastic preforms, removed by the removal device, jointly in a predefined transport direction, wherein the apparatus has an inspection device that inspects the manufactured plastic preforms,
wherein
the inspection device has at least one infrared image recording device that records a spatially resolved image of at least one region of a plurality of the manufactured plastic preforms and outputs at least one value that is characteristic of a physical property of the plastic preforms inspected.

13. The method according to claim 12,
wherein
a receiving device receives the plastic preforms from the carrier.
